(19) United States
(12) Patent Application Publication
(10) Pub. No.: US 2011/0045129 A1
(43) Pub. Date: Feb. 24, 2011

(54) Plant Extracts as Additives for Yeast Raised Baked Goods

(75) Inventors: Andreas Funke, Dietenheim (DE); Michael Seitter, Vohringen (DE); Ceferino Pascual, Barcelona (ES); Agustin Villar Gonzalez, Barcelona (ES)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/848,655

(22) Filed: Aug. 2, 2010

(30) Foreign Application Priority Data
Aug. 4, 2009 (EP) 09010035.5

(51) Int. Cl. A21D 8/04; A21D 10/00; A21D 13/00

(52) U.S. Cl. 426/21; 426/62; 426/549

(57) ABSTRACT

The present invention relates to the use of an active component for improving dough stability of yeast dough, for making baked goods, and/or for improving the volume of yeast raised baked goods, wherein the active component comprises a member selected from the group consisting of an extract of any part of a plant of the species ginseng (Panax ginseng C. A. Meyer), an extract of any part of a plant of the species notoginseng (Panax pseudoginseng), an extract of any part of a plant of the species washnut (Sapindus mucorossi), an extract of any part of a plant of the species butcher's broom (Ruscus aculeatus), an extract of any part of a plant of the genus yucca, an extract of any part of a plant of the species Hoodia gordonii, a glycoside of a chemical compound comprising a gonane structure, and a mixture of two or more of these.

### CROSS-REFERENCES TO RELATED APPLICATIONS

The Present application claims priority under 35 U.S.C. §119 to European Patent Application 09010035.5, filed Aug. 4, 2009, which is incorporated herein by reference in its entirety.

### FIELD OF INVENTION

The present invention relates to the use of an active component for improving dough stability of yeast dough for making baked goods and/or for improving (i.e., enhancing) the volume of yeast raised baked goods.

### BACKGROUND OF THE INVENTION

In order to improve the stability of yeast dough and/or in order to improve (i.e., to increase) the volume of baked goods, such as bread or rolls, obtained from yeast dough, emulsifiers and/or enzymes are added to yeast dough before baking.

Improvement of the stability of yeast dough means increasing the tolerance of the dough against a kneading time that is longer than optimal, i.e., even if the dough is kneaded longer than necessary the properties of the dough and of the resulting baked goods do not deteriorate. Furthermore, improvement of the stability of yeast dough means increasing the tolerance of the dough against a fermentation time that is longer than optimal. Furthermore, improvement of the stability of yeast dough means increasing the shock resistance of the dough.

The following emulsifiers and enzymes are known and are used for manufacturing yeast raised baked goods. DATEMs (diacetyltartaric acid esters of monoglycerides and diglycerides; E-number according to EU legislation: E 472e/E 472f; FDA-CFR-no: 184.1101) improve dough stability and volume of baked goods. SSL (sodium stearoyl-2-lactylate; E-number according to EU legislation: E 481) improves dough stability and volume and has an antistaling effect. Lipases, especially phospholipases improve dough stability and volume.

The mode of action of these emulsifiers is based on interactions with the wheat gluten, which is strengthened in such a way that the gas formed by the yeast can be better held back in the dough. The result is better dough stability (higher mixing tolerance, higher fermentation tolerance and higher shock tolerance) and a higher volume of the baked goods obtained after baking. Lipases and phospholipases create active emulsifiers from precursors present in wheat flour which then have a similar effect.

The effects of a DATEM during bread making begin immediately with the mixing process and continue until baking is completed. Greater dough mixing tolerance is achieved, i.e., at too long mixing time baked goods of good shape and good volume are obtained. Increased gas-retaining capacity and improved fermentation tolerance is achieved, i.e., at too long fermentation times baked goods of good shape and good volume are obtained. Greater dough stability and shock tolerance is achieved, especially under the stressed conditions of larger commercial or plant bakeries. Increased bread volume and enhanced over-all appearance is achieved. Finer or more controlled crumb structure according to the style of the product is achieved.

Typical dosage level of DATEMs used are 0.2-0.5% on flour.

These important improvements of both dough handling and final baked goods quality are not only due to the fundamental surface active effects of DATEMs, but also to specific molecular interactions which occur between DATEMs and lipids, proteins and carbohydrates of the flour. The interaction between DATEMs and gluten is of the utmost importance. Hydrogen bonding between the DATEM molecule and amino acid residues of gluten are formed, leading to a stronger and more developed gluten network. The dough becomes more stable and shows an improved gas-retaining capacity which leads to the above advantages.

SSL in principle has the same effect, but not quite as strong as DATEM.

EP 914 777 A describes the preparation of white bread by baking a dough comprising flour, yeast, yeast food, sugar, salt, skim milk powder, shortening, water and a complex of gliadin with yucca saponin. The white bread prepared has more excellent specific volume than a bread prepared using a dough comprising only gluten, gliadin or glutenin. The use of an extract of a yucca plant is not disclosed. An improvement of dough stability is not disclosed.

The use of ginseng as a spice in several baked goods, e.g., buns, is known. Recipes can be found on the internet. It is not known, however, to use ginseng extract instead of powdered parts of ginseng. Obviously powdered ginseng parts are different from ginseng extract and different effects are to be expected because, amongst other reasons, powdered ginseng comprises intact cells of the ginseng plant and does not release the same active components to the same extent as an extract of a ginseng plant.

JP 2003-023954 A describes the preparation of bread by baking dough comprising wheat flour, water, salt, sugar, boiled rice, yeast, potato, apple and ginseng. The Ginseng extract is not disclosed.

WO 2007/053846 describes a composition comprising an extract of a plant of the genus Pinus and an extract of a plant of the genus Hoodia or Trichocaulon. This composition is incorporated into various foods, drinks, snacks, non-diet products such as candy, snack products such as chips, prepared meat products, milk, cheese, yogurt, sport bars, sport drinks, mayonnaise, salad dressing, bread or drinks. This is done to treat weight loss.

WO 2008/130113 describes a health food composition for prevention and treatment of a periodontal disease, comprising one of respective extracts from Rehmanniae Radix Preparata and Panax notoginseng or a mixture of the respective extracts. A flour mixture comprising 0.5-5.0 wt % of the extract was used to make breads, cakes, cookies and noodles. An extract of Panax pseudoginseng is not disclosed.

CN 1 919 011 A describes the preparation of bread from a dough comprising Broomrape. The use of an extract of Broomrape is not disclosed.

JP 2000-245415 A describes the preparation of bread by baking a dough comprising wheat flour, yeast, water and yucca extract.

KR 2005-0030978 A describes the production of pizza dough by mixing yeast, salt, sugar, water wheat flour and ginseng in vegetable oil. The use of a ginseng extract is not disclosed.

The problem underlying the present invention is to provide further additives for the dough of yeast raised baked goods that provide for at least some of the advantageous effects that DATEMs provide for.

This problem is solved by using an active component according to the present invention for improving dough stability of yeast dough for making baked goods and/or for improving (i.e., enhancing) the volume of yeast raised baked goods.

### DETAILED DESCRIPTION OF PREFERRED EMBODIMENTS

The present invention relates to the use of an active component for improving dough stability of yeast dough for making baked goods and/or for improving (i.e., enhancing) the volume of yeast raised baked goods, wherein the active component comprises a member selected from the group consisting of an extract of any part of a plant of the species ginseng (Panax ginseng C. A. Meyer), an extract of any part of a plant of the species notoginseng (Panax pseudoginseng), an extract of any part of a plant of the species washnut (Sapindus mucorossi), an extract of any part of a plant of the species Butcher's Broom (Ruscus aculeatus), an extract of any part of a plant of the genus yucca, an extract of any part of a plant of the species Hoodia gordonii, a glycoside of a chemical compound comprising a gonane structure and a mixture of two or more of these extracts and/or substances.

In one embodiment the present invention relates to a yeast dough composition comprising (a) flour, (b) water, (c) yeast, and (d) at least one active component as described above. In certain preferred embodiments, said active component is not an extract of any part of a plant of the species Hoodia gordonii, and that said active component is not an extract of any part of a plant of the genus yucca. In certain preferred embodiments, the yeast dough comprises (a) about 100 parts by weight of flour, (b) of from about 40 to 7 parts by weight of water, and more preferably of from about 50 to 60 parts by weight of water, (c) of from about 1 to 7 parts by weight of said yeast, and more preferably 3 to 5 parts by weight of said yeast, and (d) of from about 0.3 to 5 parts by weight of said active component. In certain preferred embodiments, the flour comprises wheat flour and/or rye flour.

In certain preferred embodiments, the active component according to the present invention is selected from the group consisting of:
an extract of any part of a plant of the species ginseng (Panax ginseng C. A. Meyer),
an extract of any part of a plant of the species notoginseng (Panax pseudoginseng),
an extract of any part of a plant of the species washnut (Sapindus mucorossi),
an extract of any part of a plant of the species Butcher's Broom (Ruscus aculeatus),
an extract of any part of a plant of the genus yucca,
an extract of any part of a plant of the species Hoodia gordonii,
a glycoside of a chemical compound comprising a gonane structure,
and a mixture of two or more of these extracts and/or substances.
In one embodiment of the present invention the extract of any part of a plant of the species ginseng (Panax ginseng C. A. Meyer) comprises an extract of ginseng roots which is preferably obtainable by extracting the roots with about 70% by weight methanol in water at a temperature of from about 25 to 35° C.

In one embodiment of the present invention the extract of any part of a plant of the species notoginseng (Panax pseudoginseng) comprises an extract of notoginseng roots which is preferably obtainable by extracting the roots with about 70% by weight methanol in water at a temperature of from about 25 to 35° C.

In one embodiment of the present invention the extract of any part of a plant of the genus yucca is an extract of yucca roots which is preferably obtainable by extracting the roots with about 70% by weight methanol in water at a temperature of from about 25 to 35° C.

In one embodiment of the present invention the extract of any part of a plant of the species Butcher's Broom (Ruscus aculeatus) comprises an extract of roots of Butcher's Broom which is preferably obtainable by extracting the roots with about 60% by weight ethanol in water, preferably at reflux temperature.

In one embodiment of the present invention the extract of any part of a plant of the species Butcher's Broom (Ruscus aculeatus) is an extract of rhizomes of Butcher's Broom which is preferably obtainable by extracting the rhizomes with about 60% by weight ethanol in water, preferably at reflux temperature.

In one embodiment of the present invention the extract of any part of a plant of the species washnut (Sapindus mucorossi) comprises an extract of ground Indian washnut in powder form which is preferably obtainable by extracting the ground Indian washnut in powder form with water at a temperature of from about 65° C.

In one embodiment of the present invention the extract of any part of a plant of the species washnut (Sapindus mucorossi) comprises an extract of ground Indonesian washnut hulls which is preferably obtainable by extracting the ground Indonesian washnut hulls with water at a temperature of from about 65° C.

In one embodiment of the present invention the glycoside of a chemical compound comprising a gonane structure comprises a ginsenoside.

In one embodiment of the present invention the glycoside of a chemical compound comprising a gonane structure comprises a glycoside of a sterol.

Accordingly the use of the active component according to the present invention for improving dough stability of yeast dough for making baked goods and/or for improving (i.e., enhancing) the volume of yeast raised baked goods is a subject of the present invention.

Further subjects of the present invention are the process for making yeast dough, the process for making yeast raised baked goods, the yeast dough and yeast raised baked goods. In one embodiment, the process for making yeast dough comprises mixing flour, water, yeast, and an active component. In one embodiment, the process for making yeast raised baked goods comprises (i) providing a yeast dough comprising (a) flour, (b) water, (c) yeast, and (d) an active component, as described in further detail above, and (ii) baking said yeast dough. Further examples of such methods will be apparent to one skilled in the art. Non-limiting examples of yeast baked raised goods are bread, rolls, baguettes, soft buns, sandwich bread, ciabatta, yeast donuts, croissants, Danish pastries, steamed buns, or pizzas.

In one embodiment of the present invention the active component according to the present invention is used in an amount of from about 0.3 to 5.0% by weight, preferably of from about 0.5 to 3% by weight, and more preferably of from about 1 to 2% by weight, of the amount of flour in the dough.

The use, the processes, the dough and the baked goods according to the present invention have many advantages. Dough stability is improved. Volume of the baked goods is improved. Natural ingredients replace processed oleochemical additives which meets modern consumer demand.

It is believed that the active substances of the extracts according to the present invention, bringing about the advantageous effects according to the present invention, are special saponins or ginsenosides or derivatives thereof. However not all saponins from any source have shown the advantageous effects according to the present invention. For example, extracts from saponin-rich plants like Siberian ginseng (Eleutherococcus senticosus) or ivy (Hedera helix) did not show good results.

Good results were obtained with extracts from ginseng (Panax ginseng C. A. Meyer) at concentrations of from about 0.3 to 5.0% by weight, preferably of from about 0.5 to 3% by weight, and more preferably of from about 1 to 2% by weight, based on the amount of flour in the dough.

### EXAMPLES

The following baking test show some of the advantageous effects brought about by the subjects of the present invention. % is % by weight, unless defined differently.

Crispy rolls (“pistolets”) were baked according to the standard baking test BR 31. The following defines the standard baking test BR 31.

### Standard Baking Test—Pistolets, BR 31: Dough Composition:

| | g | % |
|---|---|---|
| wheat flour (0.5% ash), untreated | 2000.00 | 100.00 |
| yeast | 120.00 | 6.00 |
| improver 70/30 having the following | 52.00 | 2.60 |
| composition: | | |
| ascorbic acid | | 0.31 |
| Nutrilife ® AM 17 (alpha-amylase, | | 0.06 |
| 50000 SKB/g | | |
| dextrose | | 50.00 |
| wheat starch | | ad 100.00 |
| salt | 40.00 | 2.00 |
| Nutrilife ® CS 30 | 0.3 | 0.015 |
| (amylase/pentosanase) | | |
| Lametop ® 300 (80% diacetyl tartaric | 0.80 or 0.00 | 0.25 or 0.00 |
| acid esters of mono- and diglycerides | | |
| and 20% calcium carbonate as | | |
| anticaking agent) | | |
| water | 1180 | 59.00 |

### Standard Baking Test—Pistolets, BR 31: Manufacture of Dough:

All ingredients as mentioned above were added into a Kemper spiral mixer SP 15. The reference contained 0.4% Lametop® 300 (80% DATEM and 20% calcium carbonate as anticaking agent). In the test trials done in parallel no Lametop® 300 was used, but Ginseng Dry Extract at 0.5, 1.0, 1.5 and 2.0% was used. The ingredients were mixed for 5.5 min at low speed and for 0.5 min at high speed. After this the doughs had a floor rest of 12 min at room temperature. 1500 g of dough were scaled and after an intermediate proof of 12 min divided into 30 pieces and shaped round by a Fortuna Automat. Then the dough pieces were put into the proofing (fermentation) chamber (35° C., 85% relative humidity). Normal fermentation time was 35 min, extended fermentation time was 45 min. Baking was done in a deck oven at approx 240° C. for approx 12 min. After cooling weight and volume was measured and specific volume was calculated.

Mixing: approximately 5 minutes slow, 1 minute fast (using a Kemper Spiral mixer SP 15)
Dough temperature: 27-29° C.
Floor rest: approx. 12 min.
Weigh-in: 1500 g (for 30 pieces)
Intermediate proof: 12 minutes
Dividing and shape round (weight of dough piece: 50 g)
Final proof: 35° C., 85% relative humidity

Additionally 150 ppm Nutrilife® CS 30 (amylase/pentosanase) was added in all trials. The formulation with DATEM (0.4% Lametop® 300 (Cognis GmbH, Monheim, Germany) based on the amount of flour) served as reference. Tests were baked without DATEM using instead Ginseng Dry Extract (Cognis GmbH, Monheim, Germany) at concentrations of 0.5%, 1.0%, 1.5% and 2.0% based on the amount of flour. The Ginseng Dry Extract was obtained by extracting roots of Panax ginseng C. A. Meyer with 70% by weight methanol in water at a temperature of 30+/−5° C.

### Results:

dough properties: comparable to reference at all dosages
dough stability (evaluated by comparing relative volumes at normal and extended proof times):
comparable for ginseng extract concentration of 1.0%, 1.5% and 2.0%
volume (in % against reference):
at 0.5% ginseng: normal proof: 93%, extended proof 92%
at 1.0% ginseng: normal proof: 101%, extended proof 101%
at 1.5% ginseng: normal proof: 98%, extended proof 101%
at 2.0% ginseng: normal proof: 100%, extended proof 103%

### Meaning of Terms Used in “Results”:

specific volume=volume per kg dough
relative volume=specific volume of the test trial compared to specific volume of the reference trial, expressed in %
normal proof: normal fermentation time
extended proof: extended fermentation time, in order to test dough stability/fermentation tolerance

What is claimed is:

1. A yeast dough composition comprising:
(a) flour;
(b) water;
(c) yeast; and
(d) at least one active component;
wherein said active component comprises a member selected from the group consisting of: an extract of any part of a plant of the species ginseng (Panax ginseng C. A. Meyer), an extract of any part of a plant of the species notoginseng (Panax pseudoginseng), an extract of any part of a plant of the species washnut (Sapindus mucorossi), an extract of any part of a plant of the species butcher's broom (Ruscus aculeatus), an extract of any part of a plant of the genus yucca, an extract of any part of a plant of the species Hoodia gordonii, a glycoside of a chemical compound comprising a gonane structure, and a mixture of two or more of these extracts and/or substances.

2. The yeast dough of claim 1, with the proviso that said active component is not an extract of any part of a plant of the species Hoodia gordonii, and with the proviso that said active component is not an extract of any part of a plant of the genus yucca.

3. The yeast dough of claim 1, comprising:
(a) about 100 parts by weight of flour;
(b) of from about 40 to 70 parts by weight of water;
(c) of from about 1 to 7 parts by weight of said yeast; and
(d) of from about 0.3 to 5 parts by weight of said active component;
wherein said yeast comprises compressed fresh yeast and/or dry yeast.

4. The yeast dough of claim 3, wherein the water is present in amount of from about 50 to 60 parts by weight, and said yeast is present in an amount of from about 3 to 5 parts by weight.

5. The yeast dough of claim 3 wherein the flour comprises wheat flour and/or rye flour.

6. The yeast dough of claim 4 wherein the flour comprises wheat flour and/or rye flour.

7. A process for making yeast dough comprising mixing flour, water, yeast and an active component, wherein said active component comprises a member selected from the group consisting of: an extract of any part of a plant of the species ginseng (Panax ginseng C. A. Meyer), an extract of any part of a plant of the species notoginseng (Panax pseudoginseng), an extract of any part of a plant of the species washnut (Sapindus mucorossi), an extract of any part of a plant of the species butcher's broom (Ruscus aculeatus), an extract of any part of a plant of the genus yucca, an extract of any part of a plant of the species Hoodia gordonii, a glycoside of a chemical compound comprising a gonane structure, and a mixture of two or more of these extracts and/or substances.

8. The process according to claim 7, with the proviso that the active component is not an extract of any part of a plant of the species Hoodia gordonii and that it is not an extract of any part of a plant of the genus yucca.

9. The process of claim 7 comprising mixing:
(a) about 100 parts by weight of flour;
(b) of from about 40 to 70 parts by weight of water;
(c) of from about 1 to 7 parts by weight of said yeast; and
(d) of from about 0.3 to 5 parts by weight of said active component;
wherein said yeast comprises compressed fresh yeast and/or dry yeast.

10. A process for making yeast raised baked goods comprising:
(i) providing a yeast dough comprising:
(a) flour;
(b) water;
(c) yeast; and
(d) at least one active component comprising a member selected from the group consisting of: an extract of any part of a plant of the species ginseng (Panax ginseng C. A. Meyer), an extract of any part of a plant of the species notoginseng (Panax pseudoginseng), an extract of any part of a plant of the species washnut (Sapindus mucorossi), an extract of any part of a plant of the species butcher's broom (Ruscus aculeatus), an extract of any part of a plant of the genus yucca, an extract of any part of a plant of the species Hoodia gordonii, a glycoside of a chemical compound comprising a gonane structure, and a mixture of two or more of these extracts and/or substances; and
(ii) baking said yeast dough.

11. The process of claim 10 with the proviso that said active component is not an extract of any part of a plant of the species Hoodia gordonii, and with the proviso that said active component is not an extract of any part of a plant of the genus yucca.

12. The process of claim 10 wherein said yeast dough comprises:
(a) about 100 parts by weight of flour;
(b) of from about 40 to 70 parts by weight of water;
(c) of from about 1 to 7 parts by weight of said yeast; and
(d) of from about 0.3 to 5 parts by weight of said active component;
wherein said yeast comprises compressed fresh yeast and/or dry yeast.

13. The process of claim 12, wherein said water is present in amount of from about 50 to 60 parts by weight, and said yeast is present in an amount of from about 3 to 5 parts by weight.

14. The process of claim 12, wherein the flour comprises wheat flour and/or rye flour.

15. The process of claim 13, wherein the flour comprises wheat flour and/or rye flour.

16. Yeast raised baked goods obtained by the process according to claim 10.

17. Yeast baked goods obtained by the process according to claim 11.

18. Yeast baked goods obtained by the process according to claim 12.
